(19) United States
(12) Patent Application Publication
(10) Pub. No.: US 2025/0231422 A1
(43) Pub. Date: Jul. 17, 2025

(54) CURVED LENSES FOR UNDERWATER VISION HAVING VARIED THICKNESS

(71) Applicant: AQUALUNG CORPORATE, Sophia-Antipolis, Valbonne (FR)

(72) Inventors: Mirko BOSIO, Valbonne - Sophia Antipolis (FR); Fabrice GREGORI, Valbonne - Sophia Antipolis (FR)

(21) Appl. No.: 18/842,321

(22) PCT Filed: Jan. 27, 2023
(86) PCT No.: PCT/EP2023/052022

§ 371 Date: Mar. 18, 2025

(30) Foreign Application Priority Data
Mar. 9, 2022 (FR) 2202060

(51) Int. Cl. G02C 7/02; A63B 33/00

(52) U.S. Cl. CPC G02C 7/02; A63B 33/002

(57) ABSTRACT

This invention concerns swimming or diving goggles for a user, characterized by the following combination of features:
the cylindrical front vision portion (3a, 3b), on a horizontal cross-section of the lens (1a, 1b), has a thickness variation of between 2.0 mm and 4.0 mm, and
the spherical lateral vision portion (4a, 4b), on a horizontal cross-section of the lens (1a, 1b), has a thickness variation of between 2.5 mm and 5 mm, and
the lenses (1a, 1b) have a cylindrical curvature on a vertical cross-section of the lens (1a, 1b) of the cylindrical front vision portion (3a, 3b), and
the lenses (1a, 1b) have a spherical curvature on a vertical cross-section of the lens (1a, 1b) of the spherical lateral vision portion (4a, 4b).

This invention concerns goggles for swimmers and divers.

For a more comprehensive understanding of the invention, a brief explanation should first be given in relation to the state of the art in the general field of underwater vision.

It should be emphasized that, in this description and in the following claims, the term “lens” is intended to refer specifically to the transparent optical diaphragm which, in use, separates the aqueous environment from the volume of air between this diaphragm and the user's facial surface surrounding his eyes.

Given the general state of the art for masks and goggles for swimmers and divers, lenses are either flat or cylindrical with a constant thickness.

It used to be commonplace to think that vision in an air/glass/water system was only possible through flat lenses, with other solutions producing severe visual distortion.

It is well known that the main problem facing underwater vision is that a non-planar lens, which in air would not cause any visible or noticeable distortion, when underwater instead forms a dioptric surface by separating the water from the air (see FIG. 20). Since water and air have quite different refractive indices, a curvature or prismatic configuration of the lens greatly affects refraction problems.

EP0824029 describes curved lenses for underwater vision. In particular, in 1998, Technisub (Aqualung Group) launched and patented the Seal mask, the first swimming mask with a non-flat lens. All subsequent lenses produced by the Aqualung Group under the Aquasphere brand from this date onwards are obtained from this curved lens profile. EP0824029 describes a lens with a cylindrical tendency on the Y axis, which represents the vertical of the face and is derived from a family of curves tangent to the X axis, horizontal to the face; in other words, it is an extruded profile with variable moving radii. This family of curves produces a lens characterized by a large radius of curvature in the central (almost flat) zone and progressively smaller radii in the outer/lateral zones.

The inner and outer faces of the lens are always strictly parallel.

It is known that human vision is characterized by optimal visual capacity in the central zone of the visual field and visual “perception” in the lateral zones. The geometry of this lens therefore responds to the need to ensure good central vision and good lateral perception, and the special geometric variance under study is designed to reduce distortion to a minimum. It also guarantees good underwater vision, characterized by a wide lateral field of vision. However, the variation in curvature on the X axis causes a deformation due to the horizontal elongation of the images which, although subjectively bearable and decodable by the eye/brain system, produces effects on visual clarity.

It should be emphasized at the outset that in the foregoing and the following, the terms “horizontal” and “vertical”, “upper” and “lower” and the like are intended to refer, for the convenience of the description, to the state in which the goggles according to the invention are worn on the face of a user who is standing upright. In general, the novelty and inventiveness of the goggles according to the invention consist, from a conceptual point of view, in a particular geometry capable of offering virtually undistorted vision, especially in those zones where the human eye is organized to see perfectly (front, top, bottom), while relegating the least perfect zone of vision to the two lateral extremities, by an appropriate selection of sectors in which the visual apparatus is not sufficiently precise to perceive defects and be thus consequently disturbed.

### The Problem-Solution Approach:

The most closely related prior art is EP0824029, as it relates to the same object of the invention, i.e. to provide swimming or diving goggles adapted to ensure, in use, fully panoramic vision over substantially 180°, free of obstacles and without significant optical disturbances (see [18] of EP0824029 B1).

EP0824029 describes goggles with a constant lens thickness of 1.5 mm, and also describes that conventional goggles are normally made of lenses having a constant thickness generally between 3 mm and 5 mm (see [14] of EP0824029 B1).

The difference between this invention and EP0824029 is that the cylindrical front vision portion (3a, 3b) of the lenses, on a horizontal cross-section, has a thickness variation of between 2.0 mm and 4.0 mm, and the spherical lateral vision portion (4a, 4b) of the lenses, on a horizontal cross-section, has a thickness variation of between 2.5 mm and 5 mm, and that there is a cylindrical curvature on a vertical cross-section of the cylindrical front vision portion (3a, 3b), and that there is a spherical curvature on a vertical cross-section of the spherical lateral vision portion (4a, 4b).

The technical effect provided by the above-mentioned difference is that the user of the goggles would not see distorted images, nor would he see flattened and horizontally dilated objects (see Table 1).

The objective technical problem of this invention is to provide curved lenses adapted for improved underwater vision, i.e. to avoid image dilation along the X (horizontal) axis causing image deformation and resulting in a flattened, horizontally dilated perception of objects. This invention avoids the above-mentioned drawbacks.

A particular object of the invention also consists of providing swimming or diving goggles adapted to ensure, in use, fully panoramic vision over substantially 170°, radically reducing visual deformations on the horizontal axis. Another object of this invention consists of improving the clarity and focus of underwater vision with a widely extended field of vision. Another particular object of the invention consists of providing swimming or diving goggles which, thanks to the special geometry of the lens, have extremely reduced hydrodynamic drag and improved stability on the user's face.

This invention is inventive in relation to EP0824029, since EP0824029 describes goggles with a constant lens thickness of 1.5 mm over the entire lens, i.e. over the cylindrical front vision portion and the spherical lateral vision portion. A person skilled in the art would find no advantage in EP0824029 in using lenses having a thickness variation of between 2.0 mm and 4.0 mm for the cylindrical front vision portion of the lenses on a horizontal section, and a thickness variation of between 2.5 mm and 5 mm for the spherical lateral vision portion of the lenses, on a horizontal section. The curved lenses of this invention are designed to reduce optical aberrations in underwater vision to a minimum, by reducing horizontal image deformation. The objective is achieved by endowing the lens with a corrective optical power obtained by means of a variation in thickness on the horizontal axis and by means of a slight cylindrical/spherical curvature on the vertical axis.

### SUMMARY OF THIS INVENTION

This invention relates to swimming or diving goggles for a user comprising:
a pair of side-by-side symmetrical lenses (1a, 1b), separate from each other or formed in a single piece,
contact means (9) connected watertight to said lenses (1a, 1b) and in use to be applied in a watertight manner to the facial surface surrounding the eyes (E1, E2) of a user and, in use, said lenses (1a, 1b) thus being placed in close proximity to the facial surface surrounding the eyes (E1, E2) of the user;
lateral connecting means (2A, 2A′) and central connecting means (2B, 2B′) on said lenses (1a, 1b), which secure said contact means (9) to said lenses (1a, 1b);
said contact means (9) are attached to said lenses (1a, 1b) by said lateral (2A, 2A′) and central (2B, 2B′) connecting means;
a goggle retaining means (11) for holding the goggles behind the user's head;
each lens (1a, 1b) having, with reference to a user's respective eye (E1, E2), an inner surface (10A) and an outer surface (10B);
each lens (1a, 1b) having, with reference to a user's respective eye (E1, E2), a cylindrical front vision portion (3a, 3b) and a spherical lateral vision portion (4a, 4b),
   characterized by the following combination of features:
the cylindrical front vision portion (3a, 3b), on a horizontal cross-section of the lens (1a, 1b), has a thickness variation of between 2.0 mm and 4.0 mm, and
the spherical lateral vision portion (4a, 4b), on a horizontal cross-section of the lens (1a, 1b), has a thickness variation of between 2.5 mm and 5 mm, and
the lenses (1a, 1b) have a cylindrical curvature on a vertical cross-section of the lens (1a, 1b) of the cylindrical front vision portion (3a, 3b), and
the lenses (1a, 1b) have a spherical curvature on a vertical cross-section of the lens (1a, 1b) of the spherical lateral vision portion (4a, 4b).

The outer surface of the lens is the surface in contact with the water, and the inner surface of the lens is the surface in contact with the air inside the swimming or diving goggles.

Preferably, the cylindrical front vision portion (3a, 3b), on the horizontal cross-section, has a thickness variation of between 2.0 mm and 3.1 mm and the spherical lateral vision portion (4a, 4b), on the horizontal cross-section, has a thickness variation of between 2.5 mm and 4 mm.

Preferably, the cylindrical front vision portion (3a, 3b), on the horizontal cross-section, has a thickness variation of between 2.5 mm and 3.1 mm and the spherical lateral vision portion (4a, 4b), on the horizontal cross-section, has a thickness variation of between 3.1 mm and 4 mm.

Preferably, the cylindrical front vision portion (3a, 3b), on the horizontal cross-section, has a thickness variation of between 3.0 mm and 4.0 mm and the spherical lateral vision portion (4a, 4b), on the horizontal cross-section, has a thickness variation of between 4.0 mm and 5 mm.

Preferably, a line of vision (Nr) emerges from the user's eyes (E1, E2) in a horizontal plane, said line of vision (Nr) being contained in a vertical plane perpendicular to said horizontal plane, said line of vision (Nr) strikes the outer surface (10B) of the lens (1a) at a first point (R) thereof in which said line of vision (Nr) is perpendicular to the inner surface (10A) of the cylindrical front vision portion (3a) of the lens (1a), and a first zone of said cylindrical front vision portion (3a) is defined by an angle alpha1 between said first point (R) and a second point (Zr) for the eye (E1, E2), said second point (Zr) corresponding to a point on the outer surface of the lens (1a) located at the lateral end of the cylindrical front vision portion (3a), said angle alpha1 being between 45° and 50° with respect to one side of said vertical plane and a second zone of said cylindrical front vision portion (3a) is defined by an angle alpha2 between said first point (R) and the central connecting means (2B, 2B′) for the eye (E1, E2), said angle alpha2 being between 10° and 15° with respect to said vertical plane, and said angle alpha2 being contained on the opposite side, with respect to said vertical plane, to that containing said angle alpha1 (see FIG. 5).

Preferably, the spherical lateral vision portion (4a) of the lens (1a) is defined by a third zone having an angle beta starting immediately after a point (Zr), said point (Zr) corresponding to a point on the outer surface of the lens (1a) located at the lateral end of the cylindrical front vision portion (3a, 3b), and said third zone terminating at the lateral connecting means (2A, 2A′) on said lens (1a) for the eye (E1, E2), said angle beta being between 10° and 20° (see FIG. 5).

Preferably, a line of vision emerging from the user's eyes (E1, E2) and passing through the spherical lateral vision portion (4a, 4b) in a horizontal plane, has a divergent angle of less than or equal to 5° with respect to a vertical plane of symmetry of the lens (1a, 1b).

Preferably, the cylindrical front vision portion (3a) of the lens (1a) is symmetrical to the cylindrical front vision portion (3b) of the lens (1b).

Preferably, the spherical lateral vision portion (4a) of the lens (1a) is symmetrical to the spherical lateral vision portion (4b) of the lens (1b).

Preferably, the inner surface (10A) and the outer surface (10B) of the lens (1a, 1b) are not parallel but intersect.

This invention also relates to swimming or diving goggles obtainable by the process comprising the steps consisting of:
endowing the lens with a corrective optical power obtained by varying its thickness along the horizontal axis, and
producing a cylindrical/spherical curvature on the vertical axis.

### DRAWINGS AND BRIEF DESCRIPTIONS THEREOF

The features and advantages of the invention will become apparent from the detailed description, made with reference to the appended drawings given by way of non-limiting example only, wherein:

FIG. 1 is a simplified schematic view showing the essential structure of a lens. In particular, it shows the position of spline A (horizontal median section of the inner surface of the lens) and spline B (horizontal median section of the outer surface of the lens).

FIG. 2 is a simplified schematic horizontal sectional view showing the essential structure of a lens. In particular, it shows details of the horizontal median section of the inner surface and the arcs RA, RB, RC, RD, RE that form spline A.

FIG. 3 is a simplified schematic horizontal sectional view showing the essential structure of a lens. In particular, it shows details of the horizontal median section of the outer surface and the arcs RA, RB, RC, RD, RE and RF that form spline B.

FIG. 4 is a simplified schematic view showing the essential structure of a lens. In particular, it shows details of the vertical cross-sections of the lenses. Vertical sections A to F on the vertical axis are arcs of variable radius. They are “suspended” from the reference spline A, which determines the horizontal axis of the lens. Spline A represents the keel of the ship, sections A to F represent the ribs, and together they define the shape of the lens.

FIG. 5 is a simplified schematic horizontal sectional view showing the essential structure of the right lens (1a) (eye E1). In particular, it shows the cylindrical vision zone (angles alpha1 and alpha2), the spherical vision zone (angle beta) and the lateral non-vision zone. The line of vision Nr from eye E1 is perpendicular to the lens (1a).

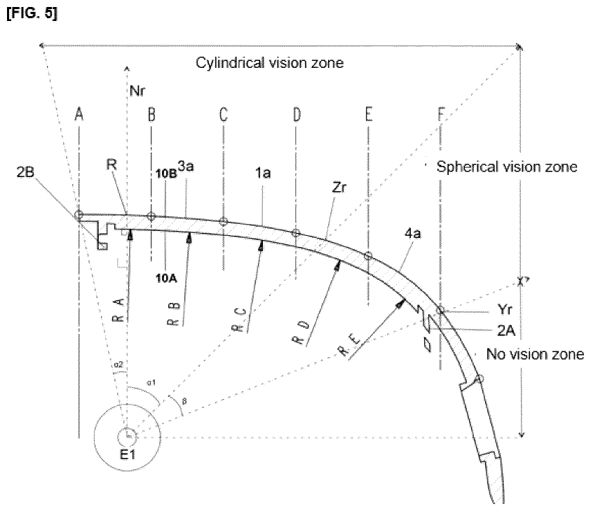

FIG. 6 is a simplified schematic horizontal sectional view showing the essential structure of the left lens (1b) (eye E2). In particular, it shows the cylindrical vision zone (angles alpha1 and alpha2), the spherical vision zone (angle beta) and the lateral non-vision zone. The line of vision Nr from eye E2 is perpendicular to the lens (1b).

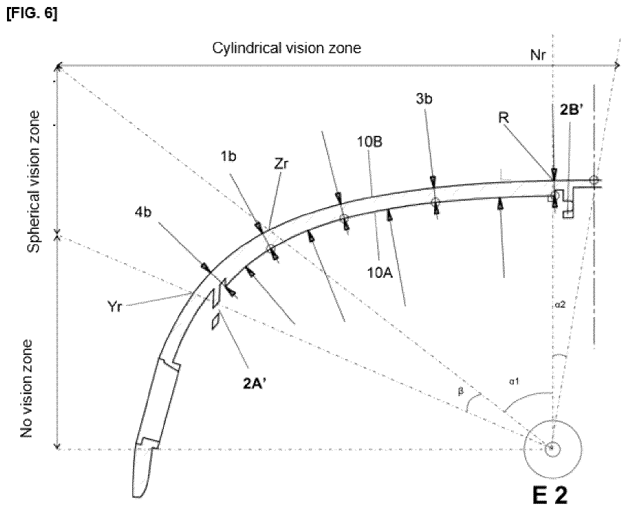

FIG. 7 is a simplified schematic horizontal sectional view of the essential structure of the two lenses. It shows the variable thickness of the lenses (1a, 1b) with certain specific thickness values in mm. The left-hand side of the figure shows the variance of the inner radii. The profile is made up of a family of variable radii that are perfectly tangent to each other. The dimensions describe the thickness variation that progressively increases in the peripheral zones. The effect of this variation is to improve underwater vision, i.e. to reduce the deformation of images perceived on the horizontal visual field. The right-hand side of the figure describes the variance of the outer radii. The profile is composed of a family of variable radii that are perfectly tangent to each other.

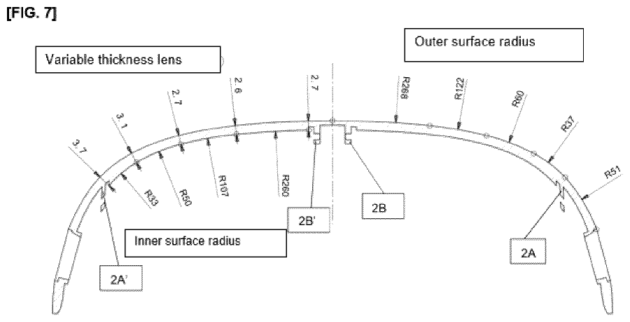

FIG. 8 is a simplified schematic view showing the essential structure of a lens. It shows details of the positioning of the vertical cross-sections of the lens and regular spacing.

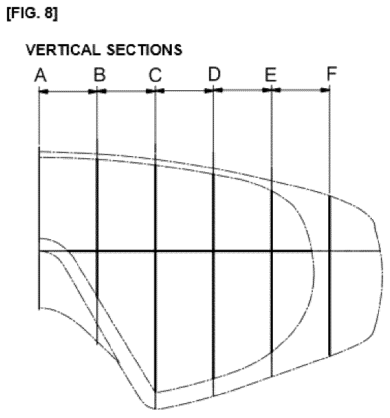

FIG. 9 is a simplified schematic view showing the essential structure of a lens. This figure describes the shape of the lens in relation to the perceptive capacity of the human eye. The central zone of the visual field, extending to around 60° horizontally, is responsible for the clear vision of objects. In this zone, the curvature of the lens is reduced to a minimum. The lateral zone of the visual field is that in which the human eye perceives but does not see with precision. This zone of the lens is called the spherical vision zone.

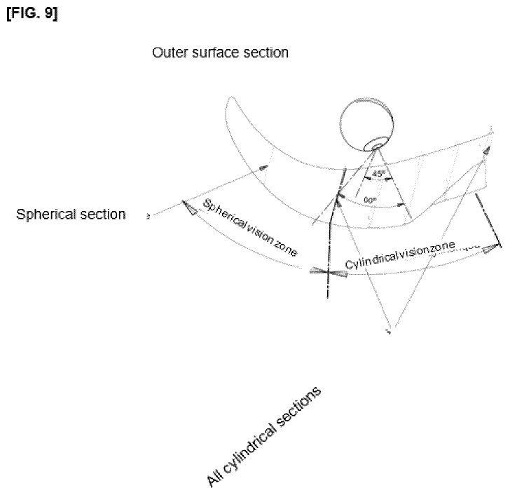

FIG. 10 is a simplified schematic view showing the essential structure of a lens. It shows the case of a double-glazed structure.

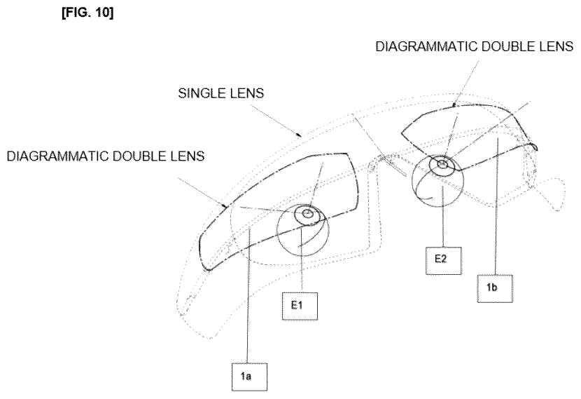

FIG. 11 shows how an object to be viewed when placed 1 m from the mask, i.e. a square object, in reality is perceived underwater with the goggles of the prior technique EP0824029, i.e. in the form of a rectangle.

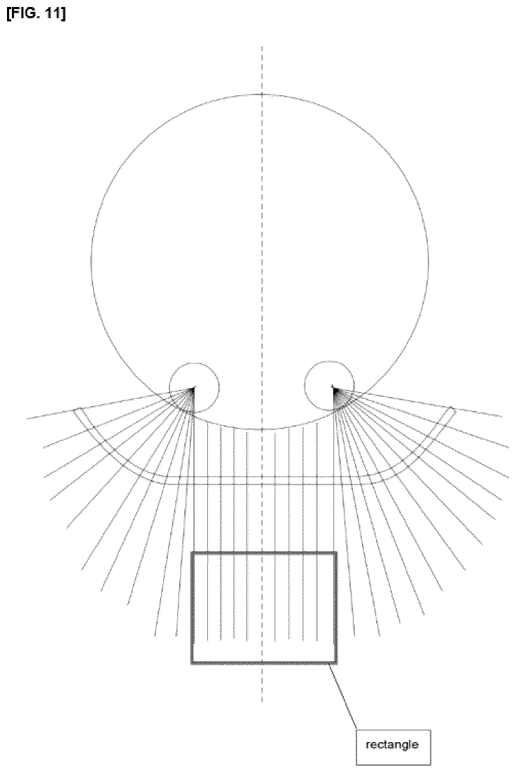

FIG. 12 shows how an object is viewed when placed 1 m from the goggles, i.e. how a square object in reality is perceived underwater with the goggles of this invention, i.e. in the form of a square. The object to be viewed undergoes no change in shape.

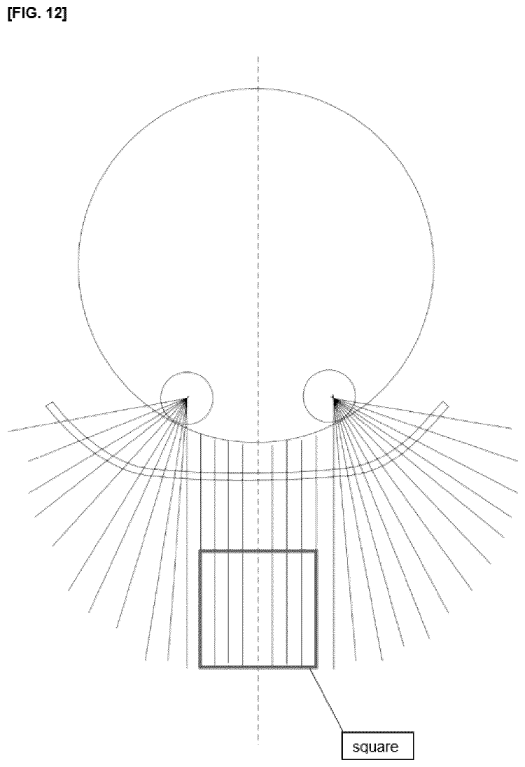

FIG. 13 shows a front-right perspective view of the swimming goggles of this invention.

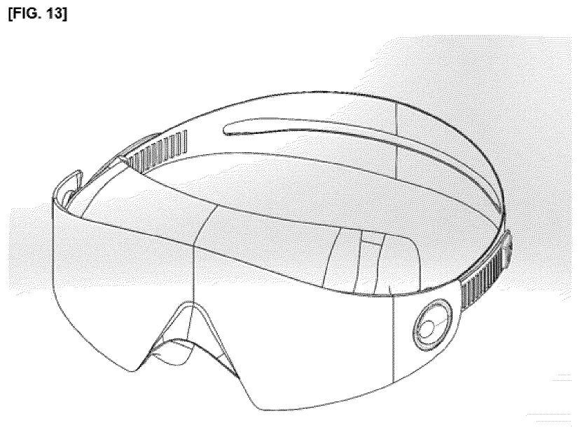

FIG. 14 shows a front-left perspective view of the swimming goggles of this invention.

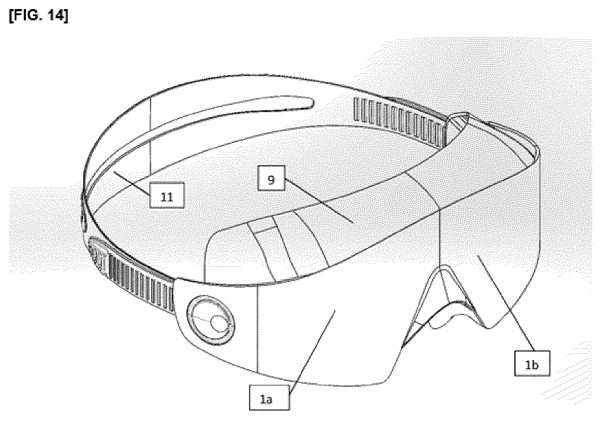

FIG. 15 shows a rear-right perspective view of the swimming goggles of this invention.

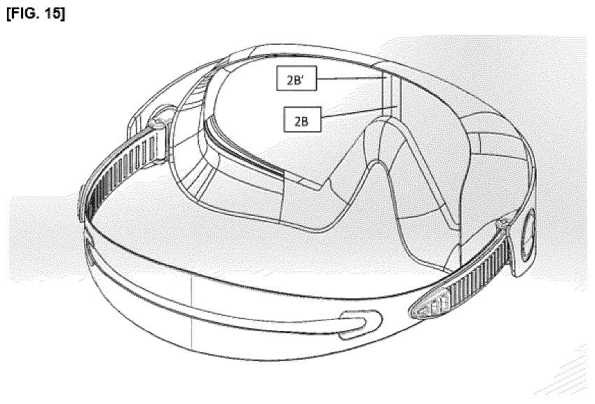

FIG. 16 shows a rear-left perspective view of the swimming goggles of this invention.

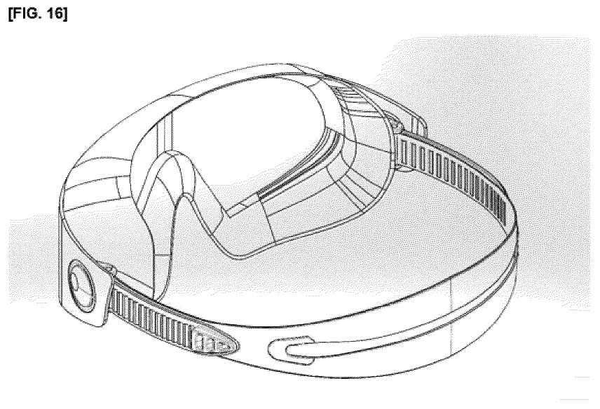

FIG. 17 shows a bottom view of the swimming goggles of this invention.

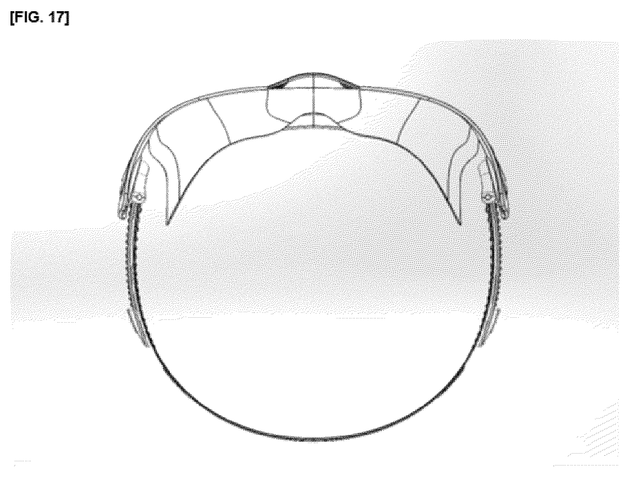

FIG. 18 shows a front view of the swimming goggles of this invention.

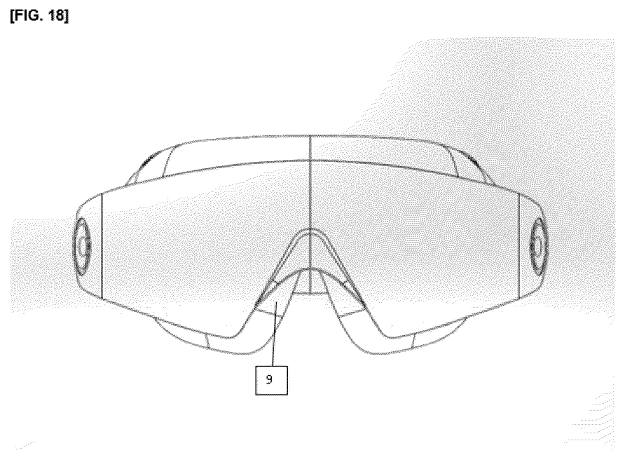

FIG. 19 shows a top view of the swimming goggles of this invention.

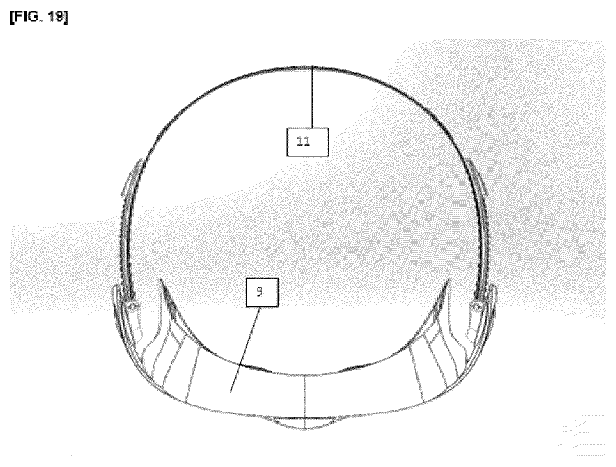

### DETAILED DESCRIPTION OF THE INVENTION

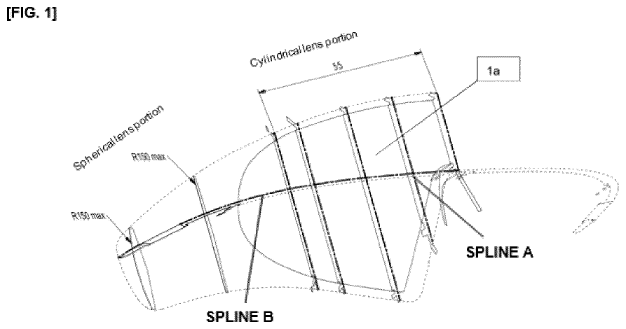

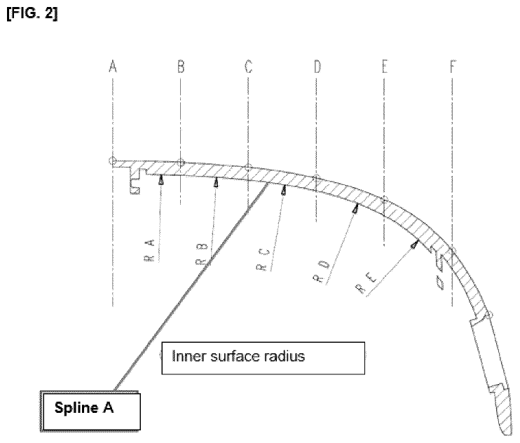

The lens of this invention consists of:
an inner surface (10A) facing the image side and, when the goggles are in use, is in contact with the air contained inside the goggles. The inner surface (10A) of the lens has, at its horizontal median section, a spline A (see FIG. 1) composed of arcs RA, RB, RC, RD, RE tangent to each other (FIG. 2), wherein RA=360±40 mm, RB=220±20 mm, RC=115±15 mm, RD=55±5 mm, RE=33±3 mm.

The transition point from RA to RB is located 14 mm from the vertical plane of symmetry of the lens, the transition point from RB to RC is located 28 mm from the vertical plane of symmetry of the lens, the transition point from RD to RC is located 42 mm from the vertical plane of symmetry of the lens and the transition point from RD to RE is located 56 mm from the vertical plane of symmetry of the lens.

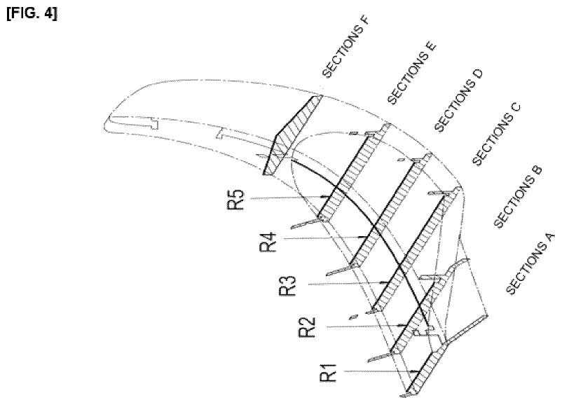

The geometry of the inner surface of the lens is generated (FIG. 4) by a succession of sections A, B, C, D, E, F arranged on spline A, section A being positioned on the vertical plane of symmetry of the lens, section B being positioned on the transition point from RA to RB, section C being positioned at the transition point from RB to RC, section D being positioned at the transition point from RD to RC, section E being positioned at the transition point from RE to RD and section F being 14 mm from section E.

Each section has an inner profile which is an arc with a different radius R1, R2, R3, R4, R5:

R1=7100±700 mm, R2=6950±690 mm, R3=7000±700 mm, R4-7100±700 mm, R5=6900±690 mm.

An outer surface (10B) facing the object side and, when the goggles are in use, is in contact with the water on the outside of the goggles. At its horizontal median section, the outer surface has a spline B (FIG. 1) that is not parallel to spline A.

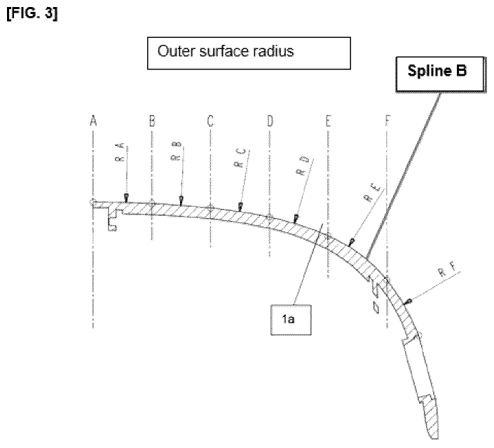

Spline B is composed of arcs RA, RB, RC, RD, RE tangent to each other (see FIG. 3) wherein RA=270±30 mm, RB=270±30 mm, RC=120±20 mm, RD=60±10 mm, RE=35±5 mm. The transition point from RA to RB is located 14 mm from the vertical plane of symmetry of the lens, the transition point from RB to RC is located 28 mm from the vertical plane of symmetry of the lens, the transition point from RD to RC is located 42 mm from the vertical plane of symmetry of the lens, the transition point from RD to RE is located 56 mm from the vertical plane of symmetry of the lens, and the transition point from RE to RF is located 70 mm from the vertical plane of symmetry of the lens.

The geometry of the outer surface of the lens is generated (see FIG. 4) by a succession of sections A, B, C, D, E, F arranged on spline B, section A being positioned on the vertical plane of symmetry of the lens, section B being positioned on the transition point from RA to RB, section C being positioned at the transition point from RB to RC, section D being positioned at the transition point from RD to RC, section E being positioned at the transition point from RE to RD and section F being 14 mm from section E. Sections A, B, C, D, E and F have an outer profile that is a straight line. Beyond section F, which is now outside the visual field, the vertical profile of the outer surface can be completed by arcs with a radius of curvature value greater than or equal to 50 mm.

Consequently, the inner (10A) and outer (10B) surfaces of the lens are NOT parallel. The inner curve of the lens is calculated to reduce lateral deformation.

The objective was achieved by giving the lens a corrective optical power, obtained by progressively thickening zones along the horizontal line. This variation has been calculated not in air, as in conventional corrective lenses, but in the optical system of actual use, i.e. air, contained in the mask/goggles, the lens, and water in the external environment.

In this way, the lens is generated to have zero optical power in water and is therefore not designed as a corrective lens, a feature of prescription lenses, but as a lens designed to reduce deformations due to the curved nature associated with the presence of the optical prism constituted by the mass of water.

The lens geometry is therefore cylindrical in the vision zone to reduce deformation along the horizontal axis to a minimum, and spherical in the lateral zone to optimize perception.

This particular optical/geometric solution can be applied both to a single lens and to two differentiated lenses. In the case of two lenses, these will be cut from the same surface as described in this patent, respecting the pupillary distance. The part of the lens used by the mask or goggle with two differentiated lenses must be in the exact position respecting the optical centers of the single lens.

Starting with the proven lens geometry described above, the object of the invention is to propose a lens still made up of a family of radii varying along the X axis, but characterized by the following innovative criteria:
1) The inner (10A) and outer (10B) surfaces of the lens are NOT parallel. The inner curve of the lens is in fact calculated to reduce lateral deformation. The objective was achieved by giving the lens a corrective optical power, obtained by progressively thickening zones along the horizontal line.
2) Knowing that, as previously indicated, a variation in curvature on the X (horizontal) axis determines a deformation due to the horizontal elongation of the images. To limit this deformation, an inner sphericity has also been introduced in the Y (vertical) axis.

Consequently, the inner surface (10A) is generated by a horizontal spline, made up of perfectly tangent compound curves and a vertical camber that extends with a fixed path above the aforementioned horizontal spline that does not extend parallel to the outer spline and variable spherical vertical sections. These curved vertical sections are also variable, starting from a radius of 7,100 mm in the central zone and rising to 10,000 mm in the lateral zone.

The inner lens surface can therefore be described as the hull of a ship. There is a horizontal line that forms the keel and curved ribs normal to it. This system of curves is the framework on which the inner lens surface is built.

### Manufacturing Process:

The lenses are injection-molded in thermoplastic, then assembled with a system of rigid frames and a silicone skirt, or the latter is directly overmolded onto the lens.

TABLE 1
comparison of this invention with the closest prior art:

| | | | Angle of | Perception |
|---|---|---|---|---|
| | | Thickness | divergence in | of a square |
| | Thickness (mm) | (mm) of | water with | object in |
| | of cylindrical | spherical | respect to a | water (at a |
| | vision zone in | vision zone in | vertical plane | distance of |
| | horizontal | horizontal | (in the | 1 meter |
| | section (at half- | section (at | cylindrical | from the |
| | height) | half-height) | vision zone) | goggles) |
| Goggles of | 1.5 (constant) | 1.5 (constant) | 15° | Rectangular |
| EP0824029 | | | see [0037] | |
| (closest prior art) | | | | |
| Protective | variable from 2.0 | variable from | <=5° | Square |
| goggles | to 4.0 | 2.5 to 5.0 | | |
| according to this | | | | |
| invention (claim | | | | |
| 1 as filed) | | | | |
| Protective | variable from 2.0 | variable from | <=5° | Square |
| goggles | to 3.1 | 2.5 to 4.0 | | |
| according to this | | | | |
| invention (claim | | | | |
| 2 as filed) | | | | |
| Protective | variable from 2.5 | variable from | <=5° | Square |
| goggles | to 3.1 | 3.1 to 4.0 | | |
| according to this | | | | |
| invention (claim | | | | |
| 3 as filed) | | | | |
| Protective | variable from 3.0 | variable from | <=5° | Square |
| goggles | to 4.0 | 4.0 to 5.0 | | |
| according to this | | | | |
| invention (claim | | | | |
| 4 as filed) | | | | |

A person skilled in the art would be surprised to learn that the perception of a square object in water would not be modified with the goggles of this invention (i.e. no deformed object, no flattened object and no horizontally dilated object), whereas the perception of a square object in water with the goggles of EP0824029 would show a rectangle instead of a square. To achieve this surprising effect, it is necessary to use a variable thickness of 2.0 to 4.0 mm of the cylindrical zone in horizontal section (at half-height) combined with the use of a variable thickness of 2.5 to 5.0 mm of the spherical lateral zone in horizontal section (at half-height), but ideally to use a variable thickness of 2.5 to 3.1 mm of the cylindrical zone in horizontal section (at half-height) combined with a variable thickness of 3.1 to 4.0 mm of the spherical lateral zone in horizontal section (at half-height), and all the above ranges must be combined with an inner sphericity introduced in the Y (vertical) axis of the lenses.

The above-mentioned technical features imply an inventive activity.

The cylindrical front vision portion (3a, 3b), in horizontal cross-section, may also have a thickness variation of between 2.0 mm and 3.1 mm, or between 2.1 mm and 3.1 mm or between 2.2 mm and 3.1 mm or between 2.3 mm and 3.1 mm or between 2.4 mm and 3.1 mm or between 2.5 mm and 3.1 mm or between 2.6 mm and 3.1 mm or between 2.7 mm and 3.1 mm or between 2.8 mm and 3.1 mm or between 2.9 mm and 3.1 mm, or between 2.0 mm and 3.0 mm, or between 2.1 mm and 2.9 mm or between 2.2 mm and 2.8 mm or between 2.3 mm and 2.7 mm or between 2.4 mm and 2.6 mm or between 2.5 mm and 3.0 mm or between 2.6 mm and 3.0 mm or between 2.7 mm and 3.0 mm or between 2.8 mm and 3.0 mm or between 2.9 mm and 3.0 mm, or between 2.1 mm and 3.9 mm, or between 2.2 mm and 3.8 mm, or between 2.3 mm and 3.7 mm, or between 2.4 mm and 3.6 mm, or between 2.5 mm and 3.5 mm, or between 2.6 mm and 3.4 mm, or between 2.7 mm and 3.3 mm, or between 2.8 mm and 3.2 mm, or between 2.9 mm and 3.1 mm and

the spherical lateral vision portion (4a, 4b), on a horizontal section, can also have a thickness variation between 3.1 mm and 3.7 mm or 3.1 mm and 4 mm, or between 3.2 mm and 4 mm or between 3.3 mm and 4 mm or between 3.4 mm and 4 mm or between 3.5 mm and 4 mm or between 3.6 mm and 4 mm or between 3.7 mm and 4 mm or between 3.8 mm and 4 mm or between 3.9 mm and 4 mm or between 3.1 mm and 3.9 mm, or between 3.2 mm and 3.8 mm or between 3.3 mm and 3.7 mm or between 3.4 mm and 3.6 mm or between 3.5 mm and 3.9 mm or between 3.6 mm and 3.9 mm or between 3.7 mm and 3.9 mm or between 3.1 mm and 3.9 mm or between 3.1 mm and 3.8 mm, or between 2.5 mm and 5.0 mm, or between 2.6 mm and 4.9 mm, or between 2.7 mm and 4.8 mm, or between 2.8 mm and 4.7 mm, or between 2.9 mm and 4.6 mm, or between 2.8 mm and 4.5 mm, or between 2.9 mm and 4.4 mm, or between 3.0 mm and 4.3 mm, or between 3.1 mm and 4.2 mm, or between 3.2 mm and 4.2 mm, or between 3.3 mm and 4.2 mm, or between 3.4 mm and 4.1 mm, or between 3.5 mm and 4.0 mm, or between 3.6 mm and 3.9 mm, or between 3.7 mm and 3.8 mm.

Any of the aforementioned ranges for the cylindrical front vision portion (3a, 3b) can be combined with any of the aforementioned ranges for the spherical lateral view portion (4a, 4b).

1. Swimming or diving goggles for a user comprising:
a pair of side-by-side symmetrical lenses (1a, 1b), separate from each other or formed in a single piece,
contact means (9) connected watertight to said lenses (1a, 1b) and adapted to be applied in a watertight manner to the facial surface surrounding the eyes (E1, E2) of the user and, in use, said lenses (1a, 1b) thus being placed in close proximity to the facial surface surrounding the eyes (E1, E2) of the user;
lateral connecting means (2A, 2A′) and central connecting means (2B, 2B′) on said lenses (1a, 1b), which secure said contact means (9) to said lenses (1a, 1b);
said contact means (9) are attached to said lenses (1a, 1b) by said lateral (2A, 2A′) and central (2B, 2B′) connecting means;
a goggle retaining means (11) for holding the goggles behind the user's head;
each lens (1a, 1b) has, with reference to a user's respective eye (E1, E2), an inner surface (10A) and an outer surface (10B),
each lens (1a, 1b) having, with reference to a user's respective eye (E1, E2), a cylindrical front vision portion (3a, 3b) and a spherical lateral vision portion (4a, 4b),
characterized in that:
the cylindrical front vision portion (3a, 3b), on a horizontal cross-section of the lens (1a, 1b), has a thickness variation of between 2.0 mm and 4.0 mm, and
the spherical lateral vision portion (4a, 4b), on a horizontal cross-section of the lens (1a, 1b), has a thickness variation of between 2.5 mm and 5.0 mm, and
the lenses (1a, 1b) have a cylindrical curvature on a vertical cross-section of the lens (1a, 1b) of the cylindrical front vision portion (3a, 3b), and
the lenses (1a, 1b) have a spherical curvature on a vertical cross-section of the lens (1a, 1b) of the spherical lateral vision portion (4a, 4b).

2. The swimming or diving goggles according to claim 1, wherein the cylindrical front vision portion (3a, 3b), on the horizontal cross-section, has a thickness variation of between 2.0 mm and 3.1 mm and the spherical lateral vision portion (4a, 4b), on the horizontal cross-section, has a thickness variation of between 2.5 mm and 4.0 mm.

3. The swimming or diving goggles according to claim 1, wherein the cylindrical front vision portion (3a, 3b), on the horizontal cross-section, has a thickness variation of between 2.5 mm and 3.1 mm and the spherical lateral vision portion (4a, 4b), on the horizontal cross-section, has a thickness variation of between 3.1 mm and 4.0 mm.

4. The swimming or diving goggles according to claim 1, wherein the cylindrical front vision portion (3a, 3b), on the horizontal cross-section, has a thickness variation of between 3.0 mm and 4.0 mm and the spherical lateral vision portion (4a, 4b), on the horizontal cross-section, has a thickness variation of between 4.0 mm and 5.0 mm.

5. The swimming or diving goggles according to claim 1, wherein a line of vision (Nr) emerges from one of the user's eyes (E1, E2) in a horizontal plane, said line of vision (Nr) being contained in a vertical plane perpendicular to said horizontal plane, and said line of vision (Nr) strikes the outer surface (10B) of the lens (1a) at a first point (R) thereof in which said line of vision (Nr) is perpendicular to the inner surface (10A) of the cylindrical front vision portion (3a) of the lens (1a), and a first zone of said cylindrical front vision portion (3a) is defined by an angle alpha1 between said first point (R) and a second point (Zr) for the eye (E1, E2), said second point (Zr) corresponding to a point on the outer surface (10B) of the lens (1a) located at the lateral end of the cylindrical front vision portion (3a), said first angle alpha1 being between 45° and 50° with respect to one side of said vertical plane and a second zone of said cylindrical front vision portion (3a) is defined by a second angle alpha2 between said first point (R) and the central connecting means (2B, 2B′) for the eye (E1, E2), said angle alpha2 being between 10° and 15° with respect to said vertical plane, and said angle alpha2 being defined on the opposite side, with respect to said vertical plane, to that defining said angle alpha1.

6. The swimming or diving goggles according to claim 1, wherein the spherical lateral vision portion (4a) of the lens (1a) is defined by a third zone having a third angle beta starting immediately after a point (Zr), said point (Zr) corresponding to a point on the outer surface (10B) of the lens (1a, 1b) located at the lateral end of the cylindrical front vision portion (3a, 3b), and said third zone terminating at the lateral connecting means (2A, 2A′) on said lens (1a, 1b) for the eye (E1, E2), said angle beta being between 10° and 20°.

7. The swimming or diving goggles according to claim 6, wherein a line of vision emerging from the user's eyes (E1, E2) and passing through the spherical lateral vision portion (4a, 4b) in a horizontal plane, has a divergent angle of less than or equal to 5° with respect to a vertical axis of symmetry of the swimming or diving goggles in their whole.

8. The swimming or diving goggles according to claim 5, wherein the cylindrical front vision portion (3a) of the lens (1a) is symmetrical to the cylindrical front vision portion (3b) of the lens (1b).

9. The swimming or diving goggles according to claim 6, wherein the spherical lateral vision portion (4a) of the lens (1a) is symmetrical to the spherical lateral vision portion (4b) of the lens (1b).

10. The swimming or diving goggles according to claim 1, wherein the inner surface (10A) and the outer surface (10B) of the lens (1a, 1b) are not parallel.

11. The swimming or diving goggles defined in claims 1 to 10 obtained according to the process comprising the steps consisting of:
endowing the lens with a corrective optical power defined by a thickness variation on the horizontal axis, and
producing a cylindrical/spherical curvature on the vertical axis.
